(19) United States
(12) Patent Application Publication
(10) Pub. No.: US 2009/0103747 A1
(43) Pub. Date: Apr. 23, 2009

(54) Power Saving File transmission in portable multimedia device

(76) Inventor: Scott C. Harris, Rancho Santa Fe, CA (US)

Correspondence Address: SCOTT C HARRIS, P O BOX 927649, SAN DIEGO, CA, 92192, US

(21) Appl. No.: 11/608,367

(22) Filed: Dec. 8, 2006

(51) Int. Cl. H04B 3/00

(52) U.S. Cl. 381/77

(57) ABSTRACT

A device for sending digital multimedia files from a digital player to an external player, for example in the vehicle. The digital files in the digital player are sent over the interface, while the playing circuitry, such as the audio circuitry, is turned off. This saves power. Additional power saving mechanisms may cache certain information from the hard drive to solid-state memory, and sending information in bursts. The sending of information can be wireless. Another aspect involves selecting an amount of bandwidth that is used for the transmission

### BACKGROUND

Portable music systems, such as iPods and other portable music systems, have become popular. Basically, each of these systems includes a repository which can store music, video or some other type of multimedia storage, typically in a compressed form, but almost universally in a digital form. The digital storage of the multimedia is typically compressed in MP3 or mpeg, or some other compressed format.

The conventional way to experience the multimedia on these devices is to push the play button and allow the device to play a multimedia file. Using the example of audio which is used throughout this specification, for example, the music is retrieved from the storage, converted to an analog form, and amplified through an audio amplifier. The thus converted to analog and amplified signal is then output through headphones.

One of the key features of these devices are the battery life. For example, the battery life may be eight hours.

In addition, users often want to listen to these devices in their automobiles. When that is done, there is typically an audio output jack, which is plugged into the automobile stereo system, which then plays the recorded music over the automobile stereo system. Other techniques have also been used, including wirelessly transmitting, for example, to an FM receiver within the automobile.

There have been suggestions to add wireless capability to portable music players. However, the wireless capability has simply been to stream the audio wirelessly to wireless headphones.

### SUMMARY

The present application defines a power saving device for allowing a personal music player to be used with an external device. One aspect allows the device to be wireless. According to the operation, the digital information, as stored on the digital storage unit, is sent in its digital form to a receiving unit. According to one aspect, the audio parts of the unit, including the audio amplifier and digital to analog converter, are maintained in a power off state during the sending mode. Since the most power intensive part of the circuitry within the unit is maintained in the low power or power off state, this operation may save considerable power.

### BRIEF DESCRIPTION OF THE DRAWINGS

These and other aspects will now be described in detail with reference to the accompanying drawings, wherein:

FIG. 1 shows a basic block diagram of the system

FIG. 2 shows a flowchart of operation.

### DETAILED DESCRIPTION

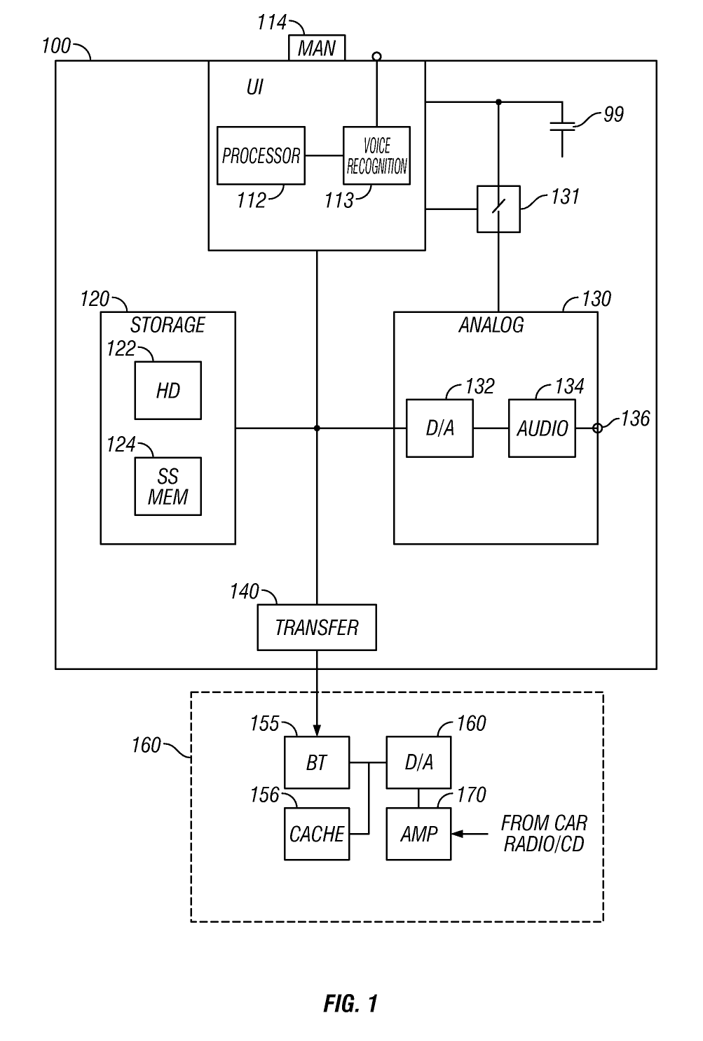

An embodiment is shown in FIG. 1. A block diagram of a portable multimedia player, 100 is shown. In the embodiment, this can be an iPod™ or other comparable device, that stores and plays music and/or music and video. A user interface 110 includes a processor 112 which operates to control aspects of the operation of the personal music player 100. The user interface 110 may be any conventional kind of interface, and may allow a remote control or local control of the unit. For example, the processor 112 may include a voice recognition module 113, connected to a microphone. The commands may be received over the microphone, recognized and used to control the processor. The commands may include “play <song name>” or other similar commands. The voice recognition module may also include a text to speech module that can play voice responses over the same speaker that plays the mp3 files. Alternatively, a manual control part 114 can be used.

The processor 112 also controls many of the subsystems in the unit. A storage part 120 may include one or more storage units. For example, this may include a miniature hard drive 122, and or may include solid-state memory 124. The solid-state memory 124 may be of the flash type. For example. either or both of the hard drive 122 or solid-state memory 124 may be used. Also, other kinds of digital storage units can be used. The memory 120 stores digital multimedia files representative of the multimedia to be played by the unit 100. The storage may use any conventional operations, well-known in the art and not described in detail herein.

The analog block 130 includes all of the circuitry that is necessary to receive the digital information from storage 120, and output it in a way that can be perceived by the user. For example, this may receive audio files, D/A convert those files in D/A converter 132, and amplify them in amplifier 134, to produce an output 136 for example over a headphone jack.

A transfer device 140 is also provided. In one embodiment, this may be a wireless transfer device, e.g. a Bluetooth transmitter or transceiver device. However, any wireless streaming device which streams according to any kind of standard can be used. For example, this can use a Zigbee device, a WiFi device, or a home RF device using shared wireless access protocol or SWAP.

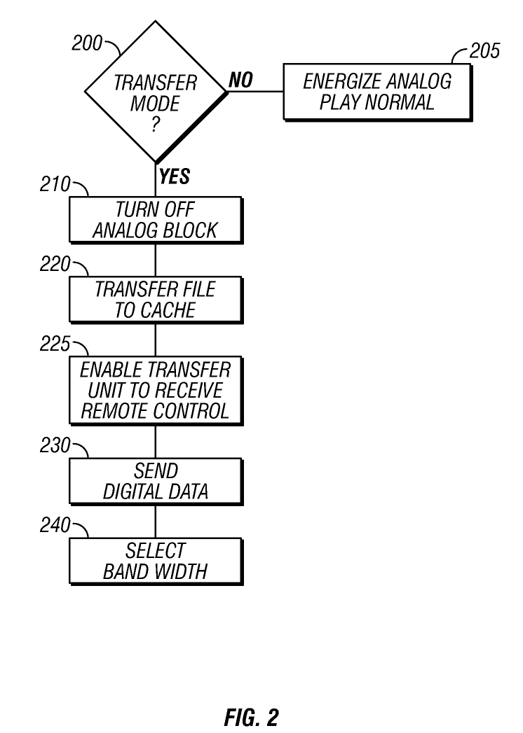

In operation, the processor 112 may operate according to the flowchart of FIG. 2. This is not to say that the processor must operate based on stored instructions (although it may) but rather the processor may control this operation using any kind of technique including field programmable gate arrays.

At 200, the system determines whether it is in transfer mode, e.g., wireless mode. Wireless mode can be set as one option on the user interface, or may have a dedicated switch. If not, 205 signifies normal playing, where information is retrieved from the memory 120, sent to the audio block 130 for D/A conversion and amplification, and output over the speaker headset line 136.

However, if wireless mode is not detected at 200, then the wireless mode is entered. At 210, the system turns off the analog block—that includes all the playing circuitry. One way to do this is with switch device 131 which is connected between the battery 99 and the analog block 130. This switch 131 may be used to interrupt entirely the power to the analog block 130. Alternatively, a more sophisticated system may be used where the audio block simply is put to sleep by the processor 112. By powering down the audio portion of the circuitry, significant power savings will be obtained. For example, this circuit may prevent the audio circuit from consuming substantial power, e.g., may reduce power consumption to zero, to 1% of normal, or to 5% of normal.

If the memory includes a hard drive 122 and solid-state memory 124, the solid-state memory 124 can be used as a cache for further power savings. Accordingly, 220 describes the optional step of transferring the entire digital file representing the entire program that is to be played, to the solid-state memory 124. As an alternative to transferring the entire digital file, some burst amount of the digital file may be transferred, for example some unit amount e.g. 500 KB, or 30 seconds worth of playing information. A hard drive 122 typically has a moving part, which the solid-state memory does not have. Hence, it may be more power efficient to retrieve the information from the solid-state memory 124, and keep the hard drive 122 moving only for enough times to actually retrieve the information therefrom.

Once entering the transfer mode, the transfer unit 140 is also enabled to receive remote control commands at 225. For example, a remote control Bluetooth command can be received.

At 230, the digital information is received, that digital information is sent directly from the memory 120 to the transfer device 140. The transfer device 140 may be Bluetooth, or any other wired or wireless format. The information is sent, as shown in FIG. 1, to a corresponding Bluetooth receiver 155 in the receiving element 160, which may be, for example, a car. Once received, the Bluetooth information is sent in its digital form to a D/A converter 165, which produces analog audio that is amplified by amplifier 170. The amplifier 170 is preferably the same amplifier that amplifies and plays audio from the car radio and CD player.

240 allows selecting the bandwidth or number of channels that can be used by the streaming. Different kinds of multimedia information may take up different amounts of bandwidth. For example, MP3 may be typically recorded at 128 or 192 Kb per second. Bluetooth has many different modes of operation. When in the single channel mode, Bluetooth is capable of streaming 108.8 kb per second. In this single channel mode, the Bluetooth operation may have the best reception. In a 5 packet mode, Bluetooth can stream approximately 720 kb per second, but does so only at the cost of losing certain benefits of the Bluetooth operation. According to one aspect, the number of channels of Bluetooth that can be used is selectable. In one mode, two separate Bluetooth transmitters or transceivers (or otherwise wireless protocol devices) are used between the Bluetooth transmitter 140 and the Bluetooth receiver 155. One of those streams may be the left channel and the other the right channel, in the case of audio for example. As an alternative, one of the streams may be the (left plus right) channel, while the other stream may be a stream representing left minus right.

One of the aspects described herein is that the information that is sent over the wireless connection may be sent in non-real time. An issue, however, exists with the copyright. The owner of the copyright of the song has certain rights to prevent the multimedia from being reproduced. Of course, the multimedia, e.g., a song, can be reproduced in various forms, referred to as fair use forms. For example, during the time the song is being played on the personal multimedia player, it may be temporarily stored in various locations in the player. Each of these would of course be fair use. Most believe that any streaming for the purpose of listening to the song in real time would also be fair use of the copyright. However, sending to another device and storing it therein, might not be considered fair use.

According to the present system, there are many ways of sending the information. The digital information may be streamed over Bluetooth in real time, so that it is received, D/A converted, and immediately played as received. It may be sent in bursts, to be maintained in a cache memory 156 within the receiving device. This may produce some battery savings in the device 100, since the device will stream at its maximum bandwidth, followed by periods of rest. This intermediate embodiment may be referred to as being bursts. An alternative embodiment may send the entire file at one shot at its fastest possible speed.

The general structure and techniques, and more specific embodiments which can be used to effect different ways of carrying out the more general goals are described herein.

Although only a few embodiments have been disclosed in detail above, other embodiments are possible and the inventor intends these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other players, kinds of multimedia and receivers are contemplated.

Also, the inventor intends that only those claims which use the words “means for” are intended to be interpreted under 35 USC 112, sixth paragraph. Moreover, no limitations from the specification are intended to be read into any claims, unless those limitations are expressly included in the claims.

The processor described herein may be any kind of processor, either general purpose. The player and processing can be done in some specific purpose computer such as a workstation. The processor may be a Pentium class computer, running Windows XP or Linux, or may be a Macintosh computer. The computer may also be a handheld computer, such as a PDA, cellphone, or laptop.

The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned.

What is claimed is:

1. A personal multimedia player, comprising:
a digital storage part, which stores digital files indicative of multimedia to be played;
an analog portion, which plays said digital files from said digital storage part;
a user interface, which allows selection of at least one of said digital files and includes a controller which controls operation of sending said at least one digital files to a receiver outside the player, and controls removing of power from said analog portion during said sending.

2. A player as in claim 1, wherein said digital files are indicative of digital compressed audio, and said analog portion includes an audio amplifier.

3. A player as in claim 1, wherein said analog portion also includes a digital to analog converter.

4. A player as in claim 1, further comprising a wireless sending device, which allows wirelessly sending information indicative of said digital files to the receiver.

5. A player as in claim 4, wherein said wireless sending device operates according to the Bluetooth format.

6. A player as in claim 4, wherein said information indicative of said digital files is information that is in digital form.

7. A player as in claim 1, wherein said sending operates to send bursts of information, with times that information is not being sent in between the times when information is sent.

8. A player as in claim 4, wherein said wireless sending device sends two independent streams of information to the receiver.

9. A player as in claim 1, further comprising a battery, powering said digital storage, said analog portion, and said user interface, and wherein said controlling removing of power prevents power from said battery from being consumed by said analog portion.

10 . A personal multimedia player, comprising:
a battery;
a media storage part, powered by said battery and storing files indicative of media to be played;
a wireless transmitting part, powered by said battery, and which enables wirelessly transmitting information indicative of said files to a receiver remote from the personal multimedia player;
a media playing part, powered by said battery, and receiving information from said media storage part upon command, and operating to play said media files upon command; and
a controller, powered by said battery, which controls said wirelessly transmitting, by entering a wireless transmitting mode in which information from said media storage part is transmitted by said wireless transmitting part, and in which said media playing part is prevented from consuming substantial power from said battery.

11. A player as in claim 10, wherein said controller controls said wireless transmitting mode to transmit in bursts of information, with times that information is not being sent in between the times when information is sent.

12. A player as in claim 10, wherein said wireless transmitting part is a Bluetooth transmitter.

13. A method, comprising:
in a first mode, enabling playing multimedia files on a personal multimedia player; and
in a second mode, enabling said multimedia files to be sent to an external player, said second mode preventing at least one circuit that is associated with playing said multimedia files in said first mode from consuming substantial power.

14. A method as in claim 13, further comprising, in said second mode, caching said multimedia files from a hard drive to a solid-state memory in bursts, and leaving times of non-operation of the hard drive in between the bursts.

15. A method as in claim 13, wherein said second mode enables said multimedia files to be sent wirelessly to the external player.

16. A method as in claim 13, further comprising selecting a bandwidth used to wirelessly send said multimedia files.

17. A method as in claim 15, wherein said sending comprises sending said files to a receiver in an automobile.

18. A method comprising:
Storing digital files representing compressed audio, in a portable multimedia player;
Playing said digital audio files in a first mode, by converting the digital audio files to an analog audio form, and producing an output indicative of the analog audio form; and
Playing said digital files in a second mode by transferring information indicative of said digital files to a receiver in an automobile, and playing information indicative of said information in said automobile.

19. A method as in claim 18, wherein said transferring comprises wirelessly transferring.

20. A method as in claim 18, further comprising, during said second mode, preventing at least one circuit that is associated with playing said audio files in said first mode from consuming substantial power
